(19) United States
(12) Patent Application Publication
(10) Pub. No.: US 2005/0041221 A1
(43) Pub. Date: Feb. 24, 2005

(54) Projector

(76) Inventor: Paolo Buroni, Cagli (IT)

Correspondence Address: Leffert Jay & Polglaze, P O Box 581009, Minneapolis, MN, 55458-1009, US

(21) Appl. No.: 10/469,885

(22) PCT Filed: Mar. 8, 2002
(86) PCT No.: PCT/IT02/00145

(30) Foreign Application Priority Data
Mar. 8, 2001 (IT) MO2001A000039

(51) Int. Cl. G03B 21/14

(52) U.S. Cl. 353/119

(57) ABSTRACT

Projector (1) enabling a remarkable flexibility of use and a marked reduction of the dimensions thereof, comprising: a main body (2) housing light generating means and heat disposal means; and a secondary body (3), removably associable to said main body (2), housing means (40) for holding and sliding a film (F), means (30) for cooling said film (F) and an optical projection group (4),

The present invention refers to a projector, in particular of the type apt to project images, slides and films onto large-sized surfaces, and optionally in Multivision, i.e. with an array of projectors synchronised thereamong.

The use of specific image projectors onto large-sized surfaces in environments destined to entertainment like, e.g., discotheques and theatres has been widespread for quite some time. The surfaces onto which the images are projected do not necessarily require a specific preparation, optionally being the common walls of the projection premises, and hence exhibiting also all the uneven spots typical of a common wall: e.g. recesses, juts, openings, doors and windows, etc.

Of late years, this specific type of projections also involves outdoor environments, like fronts of monuments and palaces. The effect resulting from these projections is particularly enthralling and spectacular, capable of engendering/creating peculiar and evocative atmospheres. This type of projections is best used during great multimedia shows and events involving vast spaces with monumental architectural surfaces, like e.g., the front of a castle or of a cathedral. Another putative field of use of said projections is that of scenic performances. Such surfaces constitute an exceptional screen for the projected images, requiring however projectors of ever-increasing candlepower.

The art has already studied and implemented projection units gradually improved with regard to the image rendering, the candlepower and, accordingly, the width of the outdoor surfaces to be used as projection screens. However, in the projectors used to date the employ of strong brilliances, i.e. of lamps characterised by an elevated candlepower and a greater concentration of the light beam, results in a disproportionate increase of the dimensions, of the weight and of the overall complexity thereof. This increase in turn causes non-negligible drawbacks.

In fact, considerable dimensions and weight, of up and beyond the 100 kg, can limit the use and the applications of such known-type projectors, which further require complex maintenance, lamp replacement and film loading interventions. Apart from this major drawback, the known projectors are affected by further problems limiting the diffusion thereof.

In fact, the known-type projectors generally employ special and large-sized (up to 24×24 cm) films, which are hard to find on the market and to expose and develop, as few laboratories are adequately equipped therefor. Above all in the case of the multivision, often the use of non-standard projectors, hence hardly found on the market, is required.

Another drawback of the known-type projectors lies in a possible imperfect positioning of the film due to slippage and deviations of the rotation rate of the take-up wheels with respect thereto.

The imperfect positioning of the film is particularly serious when, due to specific requirements, a multivision with the concomitant use of a plurality of projectors is carried out. In these cases, the required overlapping and/or concomitance of the images is compromised, with the decaying or the undoing of the desired visual effects. To date, the attempts to obviate this drawback resulted in the adoption of punched strips or the like onto the film edges. This punching entails high costs and requires the employ of skilled personnel. Another drawback in the known-type projectors lies in the difficult cooling of the film subjected to ever-increasing candlepower, with temperatures onto the film that can even exceed the 200° C.

U.S. Pat. No. 3,712,725 A (Eckerdt) discloses an adapter for enabling a slide tray projector to project film strip but intended to allow the view of images in proximity of the projector, thus no requiring special features for cooling the film strip.

DE 421,372 C (Rohde) discloses a film projector wherein an air flow is driven through the assembly supporting the film but not directly on the film, thus only allowing the heat removal from said assembly which is directly illuminated by the light source. In both cases, means for holding the film are positioned at least in part outside the adapter or the assembly as well, to maintain the film (when not illuminated) in a cooler environment.

The technical problem underlying the present invention is that of providing a projector allowing to obviate the problem of the dimensions and of the excessive weight, allowing a greater effectiveness and an effective adaptation to elevated candlepowers, at the same time providing a substantial portability of the film to be projected in a specific housing to be directly mounted on the projector body.

This problem is solved by a projector, comprising:
a main body, housing light generating means and heat disposal means; and
a secondary body, removably associable to said main body, housing means for holding and sliding a film and an optical projection group,
   characterised in that said secondary body houses means for cooling said film having a fan, located at the bottom edge of the film, so as to generate a cooling flow tangential to both the surfaces of said film.

The main advantage of the projector according to the present invention lies in subdividing the componentry so as to make more flexible and practical any function associated thereto, concomitantly remarkably reducing the bulks and the weights thereof.

As it will be apparent hereinafter, preferred embodiments of the projector enable to satisfy further needs. In particular, a first object of the present projector is to implement a projector, employable in multivision, provided with high candlepower and yet being highly compact and weight-light, capable of using standard-type films, e.g. multisize 6×7 cm and 6×6 cm, or 70 mm and 24×36 ones with a simple adapter, with no need to add perforations to an unpunched film.

Other objects of the present invention are to manufacture a projector having a quick and reliable system for loading the film and also to provide the former with an effective forced cooling of the latter. A further object of the present invention is to install an active frame synchronization system with a limited maximum error, e.g. of +/−0.05 mm per 100 frames in the 6×7 cm format.

The present invention will hereinafter be described according to a preferred embodiment thereof, given by way of example and without limitative purposes, making reference to the attached drawings, wherein:

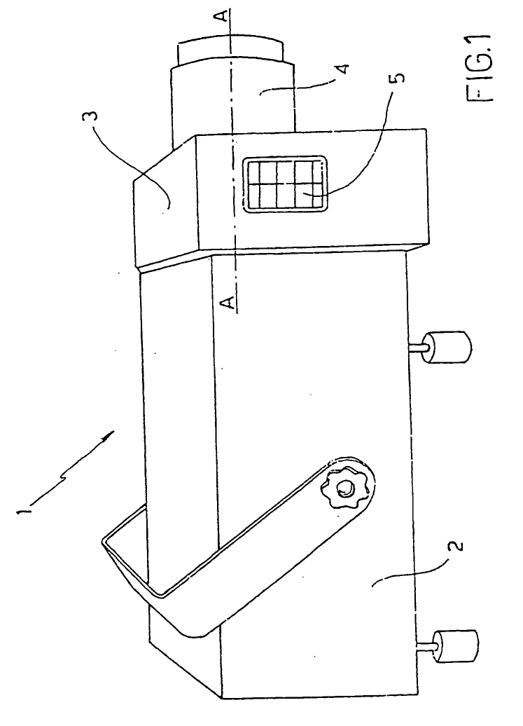

FIG. 1 is a perspective view of a projector according to the invention, comprising a main body and a secondary body thereof;

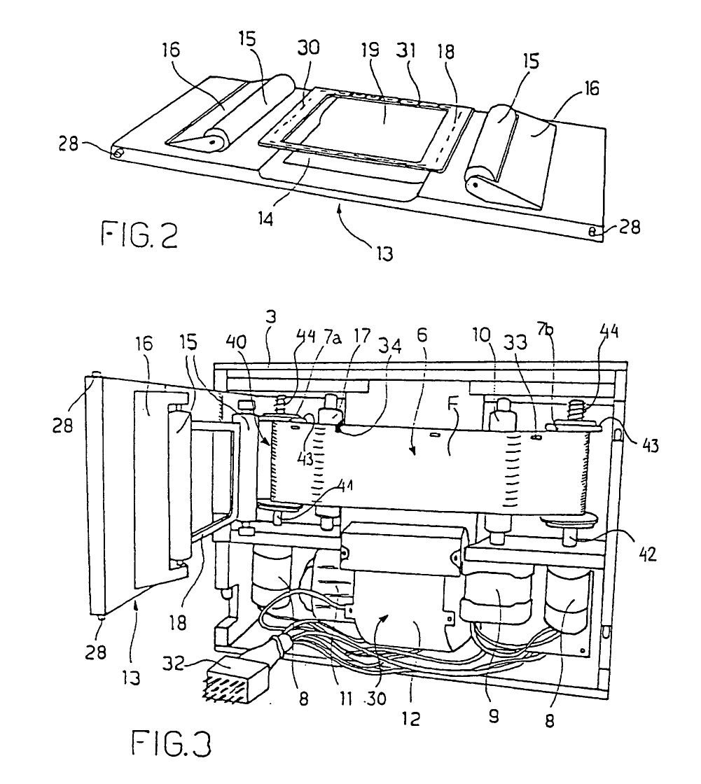

FIG. 2 is a perspective view of a detail associated to said secondary body;

FIG. 3 is a perspective view of said secondary body incorporating the detail of FIG. 2;

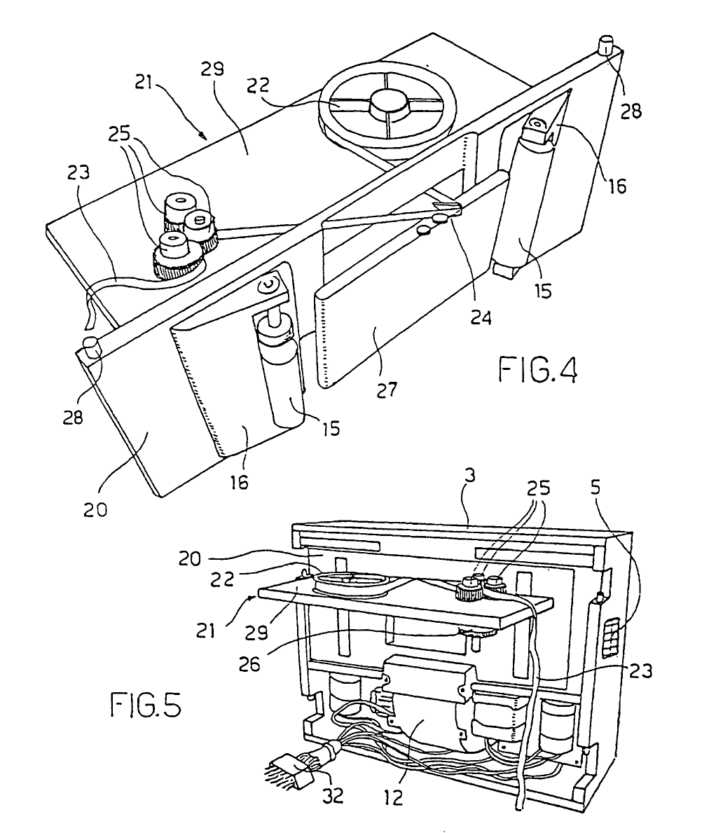

FIG. 4 is a perspective view of a specific attachment associated to said secondary body; and

FIG. 5 is a perspective view of said secondary body incorporating the specific attachment of FIG. 4.

With reference to FIG. 1, the reference number 1 generally indicates a projector of the high candlepower type, i.e. destined to project onto wide surfaces, and apt to operate in multivision, which comprises a reciprocally detachable main body 2 and a secondary body 3. In particular, the main body 2 is boxed and parallelepiped-shaped, having a substantially horizontal development with a rear end, and a front end to which said body 3 is removably associated.

The main body 2 houses light generating means, i.e. lamps having the candlepower required for the projection over wide surfaces, a primary optical group which concentrates the light onto the film to be projected, and heat disposal means, i.e. suitable fans for forcedly cool the inside thereof, with vents and fins formed thereon. The body 2 will be made of a material having an elevated thermal conductivity, like anodised aluminium.

The secondary body 3 (FIG. 3) can be mounted onto the main body 2 by lever couplings 28. The former substantially forms the driving device of the film to be projected and it comprises an optical projection group 4, a control button strip 5 and means, generally indicated with 40, for holding and sliding a film.

Such means 40 hold a film F stretched on a projection area 6, the primary optical group of the main body 2 and the optical projection group 4 resting thereon. At each side of this area 6, the holding and sliding means 40 comprises on the one hand a wind shaft 41, onto which a film, initially wound on a start spool 7a, is mounted, and on the other hand a rewind shaft 42, about which a take-up spool 7b gradually winds up as the projection goes on.

Each shaft 41, 42 has a length such as to house films of different sizes, and moreover comprises, at a respective end, presser members 43, each kept pressed onto the top edge of the film F by a respective spring 44. The presser members keep the film F in the projection position. Said means 40 further comprises electrical and mechanical members apt to shift the film F stretched between the two spools 7a, 7b. These members are power-supplied via a dedicated outlet 32.

Among said electrical and mechanical members there are indicated two ratiomotors 8, each dedicated to said two spools 7a, 7b, a first motor drive 9 apt to generate a step-by-step motion, connected to a motor wheel 10 which is located adjacent to the rewind shaft 42.

The secondary body 3 further comprises means 30 for cooling the film, having a second motor drive 11 that actuates a radial-flow fan 12. In particular, the fan 12 is located at the bottom edge of the film in said projection area 6 and it generates a cooling flow tangential to both the surfaces of the film F, as well as substantially perpendicular to the path thereof. At the back of the secondary body 3, i.e. at the portion thereof destined to contact the main body 2, there is located a first supporting plate 13. The latter, when it is completely constrained to the former, is parallel to the sliding direction of the film F and orthogonal to an axis of projection A-A. Said plate 13 has an opening 14 centered with respect to the axis of projection A-A. Said opening has dimensions not smaller than those of the frames impressed onto the film F.

With reference to FIGS. 2 and 3, onto the surface of the first plate 13 facing the inside of the secondary body 3, two idle wheels 15 are constrained whose axis of rotation is orthogonal to the motion plane of the film. Each of said idle wheels is located in substantial correspondence to the vertical edges of the opening 14 and is constrained to a support 16, which in turn is elastically constrained to the first plate 13. Each of the two idle wheels 15, when said first plate is constrained to the secondary body 3, corresponds to and is into contact with two wheels constrained to the secondary body 3. The first wheel 17 is idle as well, whereas the second wheel 10 has already been defined as motor wheel, connected to the first motor drive 9.

Onto the surface of the first supporting plate 13 facing the inside of the secondary body 3 also a frame-shaped film pressure frame 18 is elastically constrained. The latter encloses an opening 19 having dimensions not smaller than those of the frames impressed onto the film F. The edges of said film pressure frame 18, which face said film F when the first plate 13 is constrained to the secondary body 3, are provided with a plurality of inserts of a non-stick material, e.g., PTFE.

Moreover, the bottom edge thereof is also provided with a plurality of nicks 31 oriented as the axes of rotation of the idle wheels 15. The radial-flow fan 12 is integrally constrained to the secondary body 3 and it is positioned below the film 6 with the air flow outlet mouth substantially centered with respect to the thickness of the latter, in order to ensure the tangentiality of the cooling flow.

A second supporting plate 20 (FIG. 4), identical in shape and dimensions to the first supporting plate 13, is interchangeable with the latter onto the secondary body 3. Said second plate is identical to the first plate also with regard to the idle wheels 15 and the related elastically constrained supports 16.

The second plate 20 bears a device 21 for applying marks 33 made of a shelf 29 which supports one idle spool 22. About the latter, a strip 23 is wound which supports a plurality of said marks.

The latter, of the label type, have dimensions of about 3×10 mm. An infrared sensor 34 is fork-shaped in order to embrace the edge of the film 6 along which the marks 33 are applied.

Said strip, in the unwinding thereof outside of said idle spool, is first inserted into an application station 24, and then into gripping members 25 made of three mutually cooperating and substantially cylinder-shaped members.

The axis of rotation of one of such gripping members is connected to shifting means 26 which are cooperating with one of the idle wheels 15, said shifting means made, in the illustrated device, of a pair of pulleys. To the shelf 29 also said gripping and shifting members are constrained.

The second plate 20 bears, onto the surface thereof facing the inside of the secondary body 3, a presser plate 27 made of a frame which, unlike the film pressure frame 18, is blind, having no opening. The presser plate 27 is elastically constrained to the second plate 20, analogously to the constraint of the film pressure frame 18 to the first plate 13. The application station 24 is constrained to the presser plate 27.

Both the first plate 13 and the second plate 20 are provided with identical fastening members 28, i.e. the said lever couplings, to the secondary body 3. Hereinafter, the operation of the projector according to the present embodiment will be described, with particular reference to the secondary body 3.

When a projection is to be carried out, the secondary body 3 is parted from the main body 2 in order to insert the film F, and the first plate 13 is released from said secondary body making use of the fastening members 28. Instead of completely releasing the first plate 13 from the secondary body 3, the former can even be only partially released, overturning it sideways as it is shown in FIG. 3. Thus, the insertion of the film is particularly easy, taking place assembling the start spool 7a at the wind shaft 41 and hooking the free end of the film F to the rewind shaft 42.

Upon installing the film F, said first plate 13 is reapplied to the secondary body 3. Thus, the section of the former stretched onto the projection area 6 between the two spools 7a, 7b, is imprisoned between the two idle wheels 15 and the corresponding wheels 17, idle, and 10, motor.

By virtue of the elastic constraint provided to the supports 16 of the idle wheels 15, the latter always exert a steady pressure onto the corresponding rolls 17 and 10, ensuring at all times a steady pressure onto said film. To the rear surface of the film F the film pressure frame 18 adheres, by virtue of its constraint elastically yielding with respect to the first plate 13, factually concurring to keep the former perfectly planar at the axis of projection A-A. Then, the secondary body 3 can again be constrained to the main body 2 and, acting onto the control button strip 5, the film F is made to slide. Thus, the selecting of all the desired positions or frames and the storing thereof by means of the electronic management logic incorporated in the secondary body 3 of the projector 1 can be carried out. Such storing is apt to involve even more than 100 positions.

Then, the projection can be started and, at any command given by the control button strip 5 or even by a remote computer, the take-up device subject matter of the present invention will exactly position the film F onto the pre-stored spot.

In order to attain the total safety and accuracy for said film, and all the more so when plural projectors 1 are used, prior to the projection the following is carried out.

Upon mounting the film F into the secondary body 3 as abovedescribed, and releasing the main body 2 from the secondary body 3, the first plate 13 is removed from the latter. The film F is installed in the latter, and, in lieu of said first plate 13, the second plate 20 is constrained thereto, always making use of the fastening members 28.

By acting onto the control button strip 5, the film F will be set into motion and the marks 33 onto the strip 23 will quickly and automatically be applied by the applying device 21 over the entire length of said film at the rate of about one mark per each frame.

Said applying device places said marks onto the 3 mm edge of the frame, thereby without interfering in any way with the projection and without weakening the film F.

The rotary motion of the motor wheel 10 is contact-driven to the corresponding idle wheel 15, and therefrom, by the shifting members 26 and the gripping members 25, to the strip 23 unwinding from the idle spool 22. Passing the strip 23 into the application station 24, the desired applying of the marks 33 onto the film F is attained.

Apparently, the applying of said marks could abide to a laxer rule, also generating rather uneven spacing between the marks, entailing no drawbacks.

In fact, the electronic management logic incorporated in the secondary body 3 will automatically provide synchronicity during the projection. The marks 33 applied onto the film F are detected by the infrared sensor 34. Said sensor 34 is apt to operate by dimming, i.e. each mark dims the infrared beam, whereas the film F is transparent thereto. The reading by a suitable sensor (not shown) of a single mark positioned onto the film edge facing that onto which the plurality of said marks is applied provides the reference for the starting of the wheel and the synchronising of the film F. Thus, the restoring of the position register after having turned off the projector, and even in the case of a blackout, is ensured.

The applying of the marks 33 can also take place with the secondary body 3 released from the main body 2, as said secondary body is provided with its own outlet 32. Upon having applied said marks onto the film F, the second plate 20 is removed from the secondary body 3, in its place the first plate 13 is installed, and the projector 1 is ready to be used.

The sole step-by-step motor drive 9 is the main motor drive, and it determines the shifting rate and accuracy of the film F, whereas the two ratiomotors 8 serve as auxiliary motor drives and control the rewinding and the unwinding of the spools 7.

An advantage provided by the structure subject-matter of the present invention lies in the certainty that the sliding of the film F is free from position deviations even at the hundredth frame. The synchronism thereby attained compensates not merely the physiological mutual film/wheels sliding, but also any sliding due to mechanical problems, wear, dust, and film aging; The active synchronisation system of the present invention positions the frames with a maximum error of +/−0.05 mm/100 (6×7 cm) frames.

Another advantage lies in the optimal cooling of the film whose two sides are concomitantly enveloped by the air flow outletted from the fan 12 positioned quite near and bottomwise to the film, in a position substantially true to the thickness thereof. There ensues the viability of a lamp exhibiting, frame size being equal, a higher candlepower, and, hence, of the projector.

Said advantage fosters other advantages, like the greater power and useful projection size, the higher brightness of the projected image and lower risks of heat-induced film deterioration, though with an extremely compact and handy projector.

A further advantage of the projector subject-matter of the present invention lies in the optional applying, automatically and within a few seconds, marks apt to synchronise the frames, with a wholly variable spacing between the same marks, as detectable by the electronic management logic incorporated into the secondary body.

This applying is attained using the second plate 20 interchangeable with the first plate 13. The presence of said marks onto the film F ensures, during the projection, a total accuracy in the shifting of said film regardless of any factor apt to alter the normal unwinding thereof.

To the abovedescribed projector a person skilled in the art, in order to satisfy further and contingent needs, may effect several further modifications and variants, all however falling within the protective scope of the present invention, as defined by the appended claims.

1. A projector (1), comprising:
a main body (2), housing light generating means and heat disposal means; and
a secondary body (3), removably associable to said main body (2), housing means (40) for holding and sliding a film (F) and an optical projection group (4),
characterised in that said secondary body houses means (30) for cooling said film (F) having a fan (12), located at the bottom edge of the film (F), so as to generate a cooling flow tangential to both the surfaces of said film (f).

2. The projector (1) according to claim 1, wherein said means (40) for holding and sliding a film (F) comprises a film wind shaft (41) about which a film (F) initially wound on a start spool (7a) is wound, and a film rewind shaft (42), about which a take-up spool (7b) gradually winds up as the projection goes on, each shaft (41, 42) having a length such as to house films of different sizes.

3. The projector (1) according to claim 1, wherein said shafts (41, 42) comprise, at a respective end, presser members 43, each kept pressed onto the top edge of the film (F) by a respective spring (44), the presser members keeping the film (F) in the projection position.

4. The projector (1) according to claim 2, wherein the means (40) for holding and sliding comprises auxiliary motor drives (8) connected to said spools (7a, 7b) for the rewinding and the unwinding of the film.

5. The projector (1) according to claim 2, wherein the means (40) for holding and sliding comprises a step-by-step motor drive (9) connected to a motor wheel (10) cooperating with an idle wheel (17), both gripping the film (F) for the sliding thereof, the step-by-step motor drive (9) being apt to determine the shifting rate and accuracy of the film (F).

6. The projector (1) according to claim 1, comprising a first plate (13) constrainable to the secondary body (3) located parallel to the film section at a projection area (6) and orthogonal to an axis of projection (A-A) so as to form, when said first plate (13) is constrained to said secondary body (3), a wall thereof facing the projection optics (4) and so as to face a projection lamp inserted in the main body (2) when the secondary body (3) is constrained to said main body; said first plate being apt, when constrained to the secondary body (3), to keep the film (F) pressed between two idle wheels (15) and the corresponding wheels (10) and (17) of the secondary body (3) and it being apt, when released from said secondary body, to ease the mounting and the dismounting of the film (F) therefrom according to a direction substantially corresponding to the axis of projection (A-A).

7. The projector (1) according to claim 1, wherein to the secondary body (3) a first plate (13), interchangeable with a second plate (20) bearing a device (21) for applying marks (33), is constrainable.

8. Projector (1) according to claim 6, wherein the first plate (13) has an opening (14) which, when said first plate is constrained to the secondary body (3), is centered with respect to the axis of projection (A-A) and has dimensions not smaller than those of the frames impressed onto the film (F); onto the surface of said first plate (13) facing the inside of the secondary body (3) the at least two idle wheels (15) and a film pressure frame (18) are constrained.

9. The projector (1) according to claim 8, wherein said idle wheels (15) have the respective axes of rotation mutually parallel and positioned orthogonal to the sliding direction of the film (F); the idle wheels (15) are constrained to the first plate (13) in a position such as to be capable of cooperating, when said first plate is constrained to the secondary body (3), with the corresponding wheels (10, 17); the idle wheels (15) have supports (16) thereof constrained to the first plate (13) in an elastically yielding way, said elastic compliance being apt to ensure steadiness of pressure between said idle wheels (15) and the wheels (10, 17), said pressure being apt to ensure the normal unwinding of the film (6) between the idle wheels (15) and the wheels (10, 17); all the wheels (15, 17, 10) are coated with friction material, e.g. gummy material.

10. The projector (1) according to claim 9, wherein the film pressure frame (18) is substantially made of a frame enclosing an opening (19), true with respect to the axis of projection (A-A) and having dimensions not smaller than those of the frames impressed on the film (F); said frame (18) being constrained to the first plate (13) by elastic supports apt to give to said film pressure frame (18) a second compliance, it also of elastic type.

11. The projector (1) according to claim 10, wherein the edges of the frame making the film pressure frame (18) have the surface thereof facing the inside of the secondary body (3) provided with a plurality of inserts (35) of a non-stick material, e.g. PTFE.

12. The projector (1) according to claim 11, wherein the bottom edge of the film pressure frame (18) is provided with a plurality of nicks (31) oriented as the axes of rotation of the idle wheels (15); jointly to the scanty thickness of the film pressure frame (18), said nicks being apt to ease the air flow for cooling the film (6) outletted from the fan (12); the reduced thickness of the film pressure frame (18) being also apt to offer the least drag to the cooling air flow outletted from said fan.

13. The projector (1) according to claim 6, wherein the first plate (13) is provided with fastening members (28) apt to enable the mere upturning thereof with respect to the sliding plane of the film (F) as well as the complete releasing of said first plate from the secondary body (3).

14. The projector (1) according to claim 7, wherein said second plate (20) has shapes and dimensions identical to those of the first plate (13) and it is provided with identical idle wheels (15) and identical fastening means (28); the device (21) for applying marks (33) is apt to the applying, onto the film (6), of a plurality of said marks, said applying being viable solely when the second plate (20) is constrained to the secondary body (3) in lieu of the first plate (13); said marks being apt to form finder members aimed at restoring the synchronism of the frames in the case wherein the auxiliary drive motors, the motor drive (9) and/or the wheels (15, 17, 10) cause deviations in the sliding of the film (F).

15. The projector (1) according to claim 14, wherein the applying device (21) comprises a shelf (29) to which there are constrained: one idle spool (22) housing a strip (23) which supports a plurality of the marks (33); a plurality of gripping members (25) apt to grip and to shift the strip (23); shifting means (26) apt to shift said gripping members, said shifting being connected to at least one of the idle wheels (15), said connection being apt, when the second plate (20) is constrained to the secondary body (3), to drive the motion of the motor wheel (10) to the strip (23) eliminating the need of a dedicated motor drive.

16. The projector (1) according to claim 14, wherein onto the second plate (20), in lieu of the film pressure frame (18), there is constrained a plate (27) of the film (F) lacking in any opening; said pressure plate being constrained to the second plate (20) in an elastically yielding way; said pressure plate having a surface destined to contact said film coated with a layer of a non-stick material, e.g. PTFE.
